(19) United States
(12) Patent Application Publication
(10) Pub. No.: US 2024/0249679 A1
(43) Pub. Date: Jul. 25, 2024

(54) DISPLAY PANEL, DRIVING METHOD THEREOF AND DISPLAY APPARATUS

(71) Applicants: Hefei BOE Joint Technology Co., Ltd., Hefei, Anhui (CN); BOE Technology Group Co., Ltd., Beijing (CN)

(72) Inventors: Wenchao BAO, Beijing (CN); Xuehuan FENG, Beijing (CN); Pengfei YIN, Beijing (CN)

(21) Appl. No.: 18/017,052

(22) PCT Filed: Feb. 11, 2022
(86) PCT No.: PCT/CN2022/075994

§ 371 Date: Jan. 19, 2023

(51) Int. Cl. G09G 3/3233

(52) U.S. Cl. CPC G09G 3/3233; G09G 2300/0842; G09G 2310/08; G09G 2320/0247

(57) ABSTRACT

A display panel, a driving method thereof and a display apparatus, including: a plurality of sub-pixels. Each sub-pixel includes a pixel circuit, and the pixel circuit includes: a light-emitting device (L); a drive transistor (M0), configured to generate a drive current driving the light-emitting device (L) to emit light according to a data voltage at a light-emitting stage (T2); a voltage control circuit (10), coupled to the drive transistor (M0) and configured to input the data voltage into the drive transistor (M0) at a data writing stage (T1); and a black frame insertion control circuit (20), coupled to the drive transistor (M0) and configured to control the drive transistor (M0) to stop generating the drive current at a black frame insertion stage (T3) after the light-emitting stage (T2).

The present application is a National Stage of International Application No. PCT/CN2022/075994, filed on Feb. 11, 2022, which is hereby incorporated by reference in its entirety.

### FIELD

The present disclosure relates to the technical field of display, in particular to a display panel, a driving method thereof and a display apparatus.

### BACKGROUND

An electroluminescent diode such as an organic light emitting diode (OLED), a quantum dot light emitting diode (QLED) and a micro light emitting diode (Micro LED) has advantages of being self-luminous, low in energy consumption and the like and is one of hot spots in the field of application research of a display apparatus at present.

### SUMMARY

A display panel provided by an embodiment of the present disclosure includes: a plurality of sub-pixels, wherein each of the sub-pixels includes a pixel circuit, and the pixel circuit includes: a light-emitting device; a drive transistor, configured to, at a light-emitting stage, generate a drive current driving the light-emitting device to emit light according to a data voltage; a voltage control circuit, coupled to the drive transistor; wherein the voltage control circuit is configured to, at a data writing stage, input the data voltage into the drive transistor; and a black frame insertion control circuit, coupled to the drive transistor, wherein the black frame insertion control circuit is configured to, at a black frame insertion stage after the light-emitting stage, control the drive transistor to stop generating the drive current.

In some examples, the black frame insertion control circuit is coupled to a gate of the drive transistor; and, the black frame insertion control circuit is further configured to, in response to a signal loaded by a first scan signal terminal, provide a signal loaded by a black frame insertion signal terminal for the gate of the drive transistor so as to control the drive transistor to stop generating the drive current.

In some examples, the black frame insertion control circuit includes: a first transistor; and a gate of the first transistor is coupled to the first scan signal terminal, a first electrode of the first transistor is coupled to the black frame insertion signal terminal, and a second electrode of the first transistor is coupled to the gate of the drive transistor.

In some examples, the voltage control circuit is coupled to the gate of the drive transistor and the second electrode of the drive transistor; and the voltage control circuit is configured to, in response to a signal loaded by a second scan signal terminal, input the data voltage loaded by a data signal terminal into the gate of the drive transistor.

In some examples, the voltage control circuit includes a second transistor and a storage capacitor; a gate of the second transistor is coupled to the second scan signal terminal, a first electrode of the second transistor is coupled to the data signal terminal, and a second electrode of the second transistor is coupled to the gate of the drive transistor; and a first electrode plate of the storage capacitor is coupled to the gate of the drive transistor, and a second electrode plate of the storage capacitor is coupled to the second electrode of the drive transistor.

In some examples, the pixel circuit further includes an auxiliary circuit; and the auxiliary circuit is coupled to a second electrode of the drive transistor, and the auxiliary circuit is configured to, in response to a signal of a third scan signal terminal, conduct an auxiliary signal terminal with the second electrode of the drive transistor.

In some examples, the auxiliary circuit includes: a third transistor; and a gate of the third transistor is coupled to the third scan signal terminal, a first electrode of the third transistor is coupled to the second electrode of the drive transistor, and a second electrode of the third transistor is coupled to the auxiliary signal terminal.

In some examples, the display panel further includes: a plurality of auxiliary signal lines; and auxiliary signal terminals of the pixel circuits in a column of sub-pixels are coupled to at least one of the auxiliary signal lines.

In some examples, the auxiliary signal terminal and the black frame insertion signal terminal are the same signal terminal.

In some examples, the display panel further includes: a plurality of black frame insertion signal lines; and a black frame insertion signal terminal of the pixel circuit in at least one sub-pixel is coupled to one black frame insertion signal line.

In some examples, the black frame insertion signal terminals of the pixel circuits in a row of sub-pixels are coupled to one black frame insertion signal line.

In some examples, black frame insertion signal lines corresponding to at least two adjacent rows of sub-pixels are mutually coupled.

In some examples, the display panel further includes a black frame insertion switching circuit; the mutually coupled black frame insertion signal lines are coupled to a black frame insertion voltage input terminal through at least one black frame insertion switching circuit; and the black frame insertion switching circuit is configured to, in response to a signal of a black frame insertion control signal terminal, input a signal loaded by the black frame insertion voltage input terminal into the mutually coupled black frame insertion signal lines.

In some examples, the black frame insertion switching circuit includes a fourth transistor; and a gate of the fourth transistor is coupled to the black frame insertion control signal terminal, a first electrode of the fourth transistor is coupled to the black frame insertion voltage input terminal, and a second electrode of the fourth transistor is coupled to the black frame insertion signal line.

A display apparatus provided by an embodiment of the present disclosure includes the above display panel.

In a driving method of a display panel provided by an embodiment of the present disclosure, a display frame includes: a plurality of row-drive time periods; each row-drive time period includes a data writing stage, a light-emitting stage and a black frame insertion stage; the plurality of row-drive time periods are divided into M time period groups, and each time period group includes N row-drive time periods, wherein M≥1, N≥1, and M and N are integers; and for each time period group, the black frame insertion stage in each row-drive time period in the time period group enters after the data writing stage of the last row-drive time period in the time period group.

In some examples, for each time period group, the black frame insertion stage in each row-drive time period in the time period group enters after the light-emitting stage of the last row-drive time period in the time period group.

In some examples, for each time period group, the black frame insertion stages in all the row-drive time periods in the time period group enter at the same time.

### BRIEF DESCRIPTION OF THE DRAWINGS

FIG. 1 is a schematic diagram of some structures of a display panel in an embodiment of the present disclosure.

FIG. 2 is a schematic diagram of some structures of a pixel circuit in an embodiment of the present disclosure.

FIG. 3 is a schematic diagram of some structures of a pixel circuit in an embodiment of the present disclosure.

FIG. 4 is a diagram of some signal timings in an embodiment of the present disclosure.

FIG. 5 is another schematic diagram of some structures of a display panel in an embodiment of the present disclosure.

FIG. 6 is another diagram of some signal timings in an embodiment of the present disclosure.

FIG. 7 is yet another diagram of some structures a display panel in an embodiment of the present disclosure.

FIG. 8 is yet another diagram of some structures of a display panel in an embodiment of the present disclosure.

FIG. 9 is yet another diagram of some structures of some signal timings s in an embodiment of the present disclosure.

FIG. 10 is yet another diagram of some structures of a display panel in an embodiment of the present disclosure.

### DETAILED DESCRIPTION OF THE EMBODIMENTS

In order to make objectives, technical solutions and advantages of embodiments of the present disclosure clearer, the technical solutions of the embodiments of the present disclosure will be clearly and fully described below with reference to the accompanying drawings of the embodiments of the present disclosure. Apparently, the described embodiments are some, but not all of the embodiments of the present disclosure. The embodiments and features in the embodiments of the present disclosure may be mutually combined without conflicts. Based on the described embodiments of the present disclosure, all other embodiments obtained by those ordinarily skilled in the art without creative work fall within the protection scope of the present disclosure.

Unless otherwise defined, technical or scientific terms used in the present disclosure should be understood commonly by those ordinarily skilled in the art of the present disclosure. “First”, “second” and similar words used in the present disclosure do not denote any sequence, quantity or significance, but are only used for distinguishing different components. “Include” or “contain” or similar words mean that a component or an item preceding the word covers components or items and their equivalents listed after the word without excluding other components or items. “Connection”, “joint” and similar words may include electrical connection, direct or indirect, instead of being limited to physical or mechanical connection.

It needs to be noted that sizes and shapes of all figures in the accompanying drawings do not reflect a true scale and are only intended to illustrate contents of the present disclosure. The same or similar reference numbers denote same or similar components or components with the same or similar functions all the time.

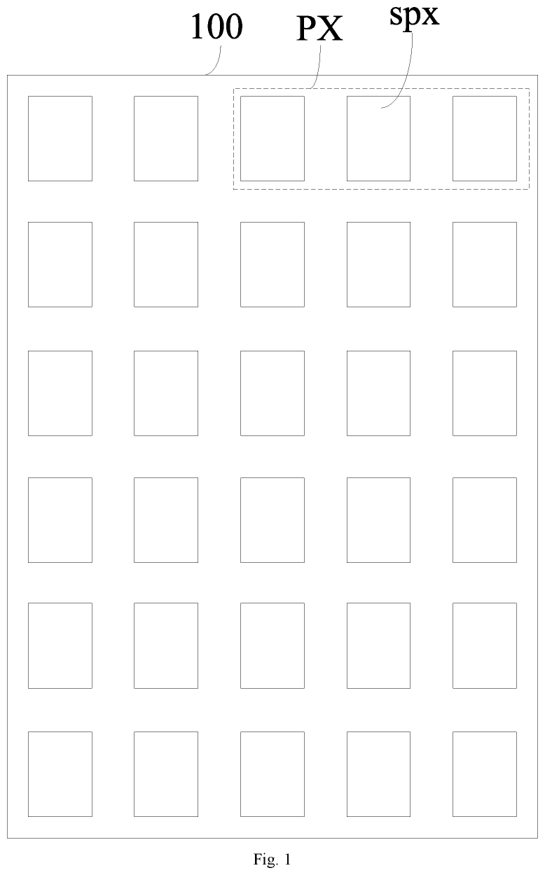

A display apparatus provided by an embodiment of the present disclosure may include a display panel. Referring to FIG. 1, the display panel may include: a base substrate 100. The base substrate 100 is provided a plurality of pixel units (PX) distributed in array. For example, each pixel unit may include a plurality of sub-pixels (spx). For example, the pixel unit may include a red sub-pixel, a green sub-pixel and a blue sub-pixel, so color mixing may be performed through red, green and blue so as to implement color display. Alternatively, the pixel unit may also include the red sub-pixel, the green sub-pixel, the blue sub-pixel and a white sub-pixel, so color mixing may be performed through red, green, blue and white so as to implement color display. Certainly, in actual application, light-emitting colors of the sub-pixels in each pixel unit may be designed and determined according to an actual application environment, which is not limited here.

In the embodiment of the present disclosure, each sub-pixel may include a pixel circuit, and the pixel circuit has a light-emitting device L and a drive transistor M0 which generates a current driving the light-emitting device L to emit light. A drive current generated by the drive transistor M0 may be input into an anode of the light-emitting device L and a corresponding voltage is loaded to a cathode of the light-emitting device L, so as to drive the light-emitting device L to emit light.

The display panel may visually and vividly display various types of information to a user, thereby being widely applied. The display panel prevails in all aspects of daily life, such as a mobile phone, a tablet computer, a television, an elevator advertising television and the like. When the display panel displays a dynamic picture, image smearing (also called dynamic image smearing) occurs in a dynamic picture switching process, which seriously affects viewing feeling of the user.

In the pixel circuit provided by the embodiment of the present disclosure, a black frame insertion control circuit 20 may control the drive transistor M0 to stop generating the drive current at a black frame insertion stage T3 after a light-emitting stage T2, so as to set a process of cutting a picture to black during light emitting of the light-emitting device L to realize a function of black frame insertion. In this way, light-emitting time can be shortened, that is, moving picture response time (MPRT) is enhanced, and a problem of image smearing is solved.

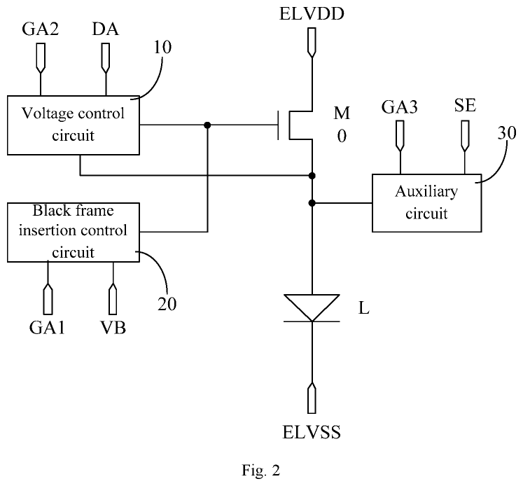

As shown in FIG. 2, the pixel circuit provided by the embodiment of the present disclosure may include: the light-emitting device L, the drive transistor M0, a voltage control circuit 10 and a black frame insertion control circuit 20. The voltage control circuit 10 and the black frame insertion control circuit 20 each are coupled to the drive transistor M0. Besides, the voltage control circuit 10 may input a data voltage into the drive transistor M0 at the data writing stage T1. The drive transistor M0 may, at the light-emitting stage 2, generate a drive current driving the light-emitting device L to emit light according to the data voltage. The black frame insertion control circuit 20 may, at the black frame insertion stage T3 after the light-emitting stage T2, control the drive transistor M0 to stop generating the drive current. In this way, the process of cutting the picture to black may be set during light emitting of the light-emitting device L to realize the function of black frame insertion. In this way, light-emitting time may be shortened, that is, MPRT is enhanced, and the problem of image smearing is solved.

In some embodiments of the present disclosure, as shown in FIG. 2, the black frame insertion control circuit 20 is coupled to a gate of the drive transistor M0. Besides, the black frame insertion control circuit 20 is further configured to, in response to a signal loaded by a first scan signal terminal GA1, provide a signal loaded by a black frame insertion signal terminal VB for the gate of the drive transistor M0 so as to control the drive transistor M0 to stop generating the drive current.

In some embodiments of the present disclosure, as shown in FIG. 2, the voltage control circuit 10 is coupled to the gate of the drive transistor M0. Besides, the voltage control circuit 10 is configured to, in response to a signal loaded by a second scan signal terminal GA2, input the data voltage loaded by a data signal terminal DA into the gate of the drive transistor M0.

In some embodiments of the present disclosure, as shown in FIG. 2, the pixel circuit further includes an auxiliary circuit 30. The auxiliary circuit 30 is coupled to a second electrode of the drive transistor M0, and the auxiliary circuit 30 is configured, in response to a signal of a third scan signal terminal GA3, to conduct an auxiliary signal terminal SE with the second electrode of the drive transistor M0.

In some embodiments of the present disclosure, as shown in FIG. 2, the first electrode of the drive transistor M0 is coupled to a first power terminal ELVDD, the second electrode of the drive transistor M0 is coupled to the anode of the light-emitting device L, and the cathode of the light-emitting device L is coupled to a second power terminal ELVSS. For example, as shown in FIG. 2, the drive transistor M0 may be set as an N-type transistor. The first electrode of the drive transistor M0 may be used as its drain, and the second electrode of the drive transistor M0 may be used as its source electrode. The drive current in a saturated state of the drive transistor M0 flows from the drain of the drive transistor M0 to its source. Besides, light emitting may be implemented usually when a voltage between the anode and cathode of the light-emitting device L is greater than its light-emitting threshold voltage. Certainly, in the embodiment of the present disclosure, description is made only by taking the drive transistor M0 being the N-type transistor as an example, a case of the drive transistor M0 being a P-type transistor has the same design principle as the present disclosure and also falls within the protection scope of the present disclosure.

In some embodiments of the present disclosure, one of the first power terminal ELVDD and the second power terminal ELVSS may be used as a high-voltage terminal and the other one of the first power terminal ELVDD and the second power terminal ELVSS may be used as a low-voltage terminal. For example, in the embodiment shown in FIG. 2, a constant first voltage Vdd may be loaded to the first power terminal ELVDD, and the first voltage Vdd is a positive voltage. A constant second voltage Vss may be loaded to the second power terminal ELVSS, and the second voltage Vss is a negative voltage or grounded and the like.

In some embodiments of the present disclosure, the light-emitting device L may be at least one of OLED, QLED, Micro LED or Mini LED. For example, the light-emitting device L may include an anode, a light-emitting layer and a cathode arranged in stack. Further, the light-emitting layer may further include a hole injection layer, a hole transport layer, an electron transport layer, an electron injection layer and other film layers. Certainly, in actual application, a specific structure of the light-emitting device L may be determined according to demands of actual application, which is not limited here.

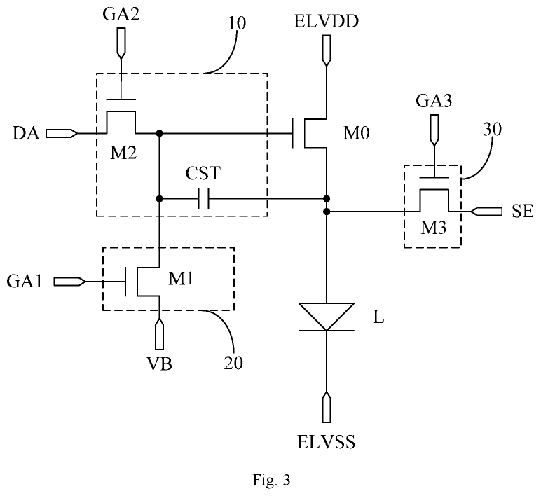

In some embodiments of the present disclosure, as shown in FIG. 3, the black frame insertion control circuit 20 includes: a first transistor M1. A gate of the first transistor M1 is coupled to the first scan signal terminal GA1, a first electrode of the first transistor M1 is coupled to the black frame insertion signal terminal VB, and a second electrode of the first transistor M1 is coupled to the gate of the drive transistor M0. For example, the first transistor M1 may be turned on under control of an effective level of a signal loaded by the first scan signal terminal GA1 and may be turned off under control of an ineffective level of the signal loaded by the first scan signal terminal GA1. For example, as shown in FIG. 3, the first transistor M1 is the N-type transistor, so the effective level of the signal loaded by the first scan signal terminal GA1 is a high level, and the ineffective level of the signal loaded by the first scan signal terminal GA1 is a low level. If the first transistor M1 is the P-type transistor, the effective level of the signal loaded by the first scan signal terminal GA1 is the low level, and the ineffective level of the signal loaded by the first scan signal terminal GA1 is the high level.

In some embodiments of the present disclosure, as shown in FIG. 3, the voltage control circuit 10 includes a second transistor M2 and a storage capacitor CST. A gate of the second transistor M2 is coupled to the second scan signal terminal GA2, a first electrode of the second transistor M2 is coupled to the data signal terminal DA, and a second electrode of the second transistor M2 is coupled to the gate of the drive transistor M0. A first electrode plate of the storage capacitor CST is coupled to the gate of the drive transistor M0, and a second electrode plate of the storage capacitor CST is coupled to the second electrode of the drive transistor M0. For example, the second transistor M2 is turned on under control of an effective level of a signal loaded by the second scan signal terminal GA2 and may be turned off under control of an ineffective level of the signal loaded by the second scan signal terminal GA2. For example, as shown in FIG. 3, the second transistor M2 is an N-type transistor, so the effective level of the signal loaded by the second scan signal terminal GA2 is a high level, and the ineffective level of the signal loaded by the second scan signal terminal GA2 is the low level. If the second transistor M2 is a P-type transistor, the effective level of the signal loaded by the second scan signal terminal GA2 is a low level, and the ineffective level of the signal loaded by the second scan signal terminal GA2 is a high level. For example, the storage capacitor CST may store a voltage input into its first electrode plate and second electrode plate.

In some embodiments of the present disclosure, as shown in FIG. 3, the auxiliary circuit 30 includes: a third transistor M3. A gate of the third transistor M3 is coupled to a third scan signal terminal GA3, a first electrode of the third transistor M3 is coupled to the second electrode of the drive transistor M0, and a second electrode of the third transistor M3 is coupled to the auxiliary signal terminal SE. For example, the third transistor M3 is turned on under control of an effective level of a signal loaded by the third scan signal terminal GA3 and may be turned off under control of an ineffective level of the signal loaded by the third scan signal terminal GA3. For example, as shown in FIG. 3, the third transistor M3 is an N-type transistor, so the effective level of the signal loaded by the third scan signal terminal GA3 is a high level, and the ineffective level of the signal loaded by the third scan signal terminal GA3 is a low level. If the third transistor M3 is a P-type transistor, the effective level of the signal loaded by the third scan signal terminal GA3 is a low level, and the ineffective level of the signal loaded by the third scan signal terminal GA3 is a high level.

For example, the signal loaded by the second scan signal terminal GA2 and the signal loaded by the third scan signal terminal GA3 may be the same, in this way, when a data voltage is input, the anode of the light-emitting device L may be reset, and problems of lagging and flickering are reduced.

It needs to be noted that in the embodiment of the present disclosure, the first electrodes of the above first transistor M1 to the third transistor M3 may be their sources, and the second electrodes may be their drains; or the first electrodes are their drains, and the second electrodes are their sources, which may be determined according to demands of actual application.

Specific structures of the voltage control circuit 10, the black frame insertion control circuit 20 and the auxiliary circuit 30 in the pixel circuit provided by the embodiment of the present disclosure are described above only for example, during specific implementation, the specific structures of the voltage control circuit 10, the black frame insertion control circuit 20 and the auxiliary circuit 30 are not limited to the above structures provided by the embodiment of the present disclosure and may also be other structures known to those skilled in the art, which is not limited here.

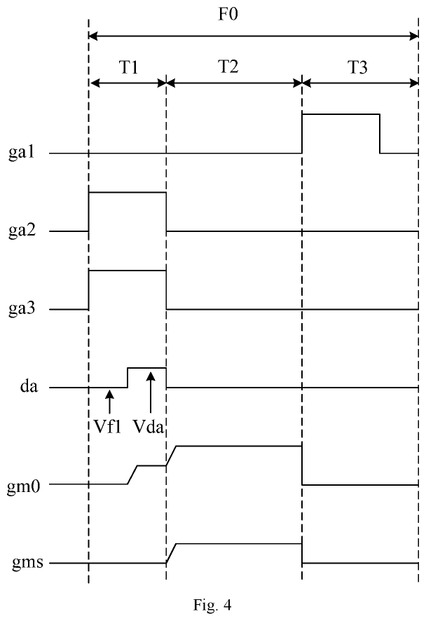

In the embodiment of the present disclosure, the display panel may work in continuous display frames so as to display a picture. For example, one display frame may include: a plurality of row-drive time periods. Each row-drive time period may include a data writing stage T1, a light-emitting stage T2 and a black frame insertion stage T3. In other words, a row of sub-pixels corresponds to one row-drive time period, the pixel circuits in the row of sub-pixels is provided with a data writing stage T1, a light-emitting stage T2 and a black frame insertion stage T3 in the row-drive time period. Taking the pixel circuit in one sub-pixel in a row as an example below, with reference to a diagram of signal timings shown in FIG. 4, a work process of the pixel circuit is described.

As shown in FIG. 4, for example, the effective level of the signal loaded by the first scan signal terminal GA1 is the high level and the ineffective level of the signal loaded by the first scan signal terminal GA1 is the low level, the effective level of the signal loaded by the second scan signal terminal GA2 is the high level, and the ineffective level of the signal loaded by the second scan signal terminal GA2 is the low level, and the effective level of the signal loaded by the third scan signal terminal GA3 is the high level and the ineffective level of the signal loaded by the third scan signal terminal GA3 is the low level.

At the data writing stage T1, the first transistor M1 is turned off under control of the low level of the signal loaded by the first scan signal terminal GA1. The second transistor M2 is turned on under control of the high level of the signal loaded by the second scan signal terminal GA2. The third transistor M3 is turned on under control of the high level of the signal loaded by the third scan signal terminal GA3. First, the data signal terminal DA is loaded with a first reset voltage Vf1, and the first reset voltage Vf1 is input into the gate of the drive transistor M0 through the second transistor M2 which is turned on so as to reset the gate of the drive transistor M0. Besides, the auxiliary signal terminal SE is loaded with a second reset voltage Vf2, and the second reset voltage Vf2 is input into the second electrode of the drive transistor M0 and the anode of the light-emitting device L through the third transistor M3 which is turned on so as to reset the second electrode of the drive transistor M0 and the anode of the light-emitting device L. Afterwards, the data signal terminal DA is loaded with a data voltage Vda, and the data voltage Vda is input into the gate of the drive transistor M0 through the second transistor M2 which is turned on so that a voltage of the gate of the drive transistor M0 is the data voltage Vda. Besides, the auxiliary signal terminal SE is loaded with the second reset voltage Vf2, and the second reset voltage Vf2 is input into the second electrode of the drive transistor M0 and the anode of the light-emitting device L through the third transistor M3 which is turned on so as to reset the second electrode of the drive transistor M0 and the anode of the light-emitting device L. It needs to be noted that (Vf2−Vss)<Vtholed, where, Vtholed represents a light-emitting threshold voltage of the light-emitting device L.

At the light-emitting stage T2, the first transistor M1 is turned off under control of the low level of the signal loaded by the first scan signal terminal GA1. The second transistor M2 is turned off under control of the low level of the signal loaded by the second scan signal terminal GA2. The third transistor M3 is turned off under control of the low level of the signal loaded by the third scan signal terminal GA3. Since the voltage of the gate of the drive transistor M0 is Vda and a voltage of the first electrode of the drive transistor M0 is Vdd, the drive transistor M0 generates a drive current IL: IL=K(Vda−Vdd−Vth)², where, K is a structure parameter, and Vth represents a threshold voltage of the drive transistor M0. The drive current is input into the light-emitting device L so as to drive the light-emitting device L to emit light.

At the black frame insertion stage T3, the first transistor M1 is turned on under control of the high level of the signal loaded by the first scan signal terminal GA1. The second transistor M2 is turned off under control of the low level of the signal loaded by the second scan signal terminal GA2. The third transistor M3 is turned off under control of the low level of the signal loaded by the third scan signal terminal GA3. The black frame insertion signal terminal VB is loaded with a black frame insertion voltage Vb1a, the black frame insertion voltage Vb1a is input into the gate of the drive transistor M0 through the first transistor M1 which is turned on so as to turned off the drive transistor M0, so generation of the drive current is stopped, then the light-emitting device L stops emitting light, and thus it is switched to a black picture. It needs to be noted that Vb1a<Vth. For example, if Vth=1 V, Vb1a may be set to be 0.5 V, and Vb1a may also be set to be 0 V or a negative value, which is not limited here.

In some embodiments of the present disclosure, blanking time may be also included after the black frame insertion stage T3. Within the blanking time, the first transistor M1 may be controlled to be turned off, the second transistor M2 and the third transistor M3 may be controlled to be turned on, a detection voltage is input into the gate of the drive transistor M0 through the second transistor M2 which is turned on, so that the drive transistor M0 generates a detection current, and the detection current may be input into the auxiliary signal terminal SE through the third transistor M3 which is turned on and flow into a connected detection circuit from the auxiliary signal terminal SE. Thus, the detection circuit may be enabled to perform external compensation on the threshold voltage of the drive transistor M0 according to the detection current. It needs to be noted that a specific process of performing the external compensation on the threshold voltage of the drive transistor M0 may be basically the same as the related art and will not be repeated here.

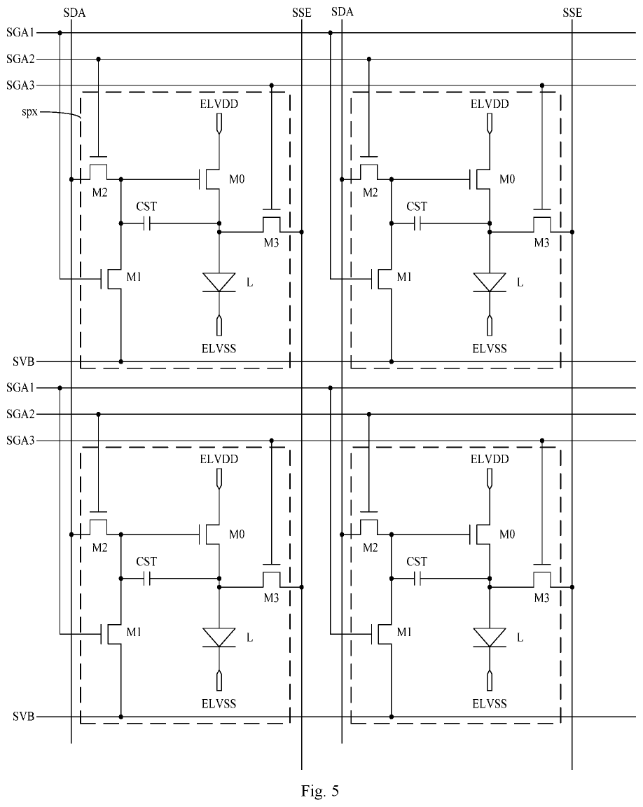

In some embodiments of the present disclosure, as shown in FIG. 5, the display panel further includes: a plurality of first scan signal lines SGA1, a plurality of second scan signal lines SGA2, a plurality of third scan signal lines SGA3, a plurality of data lines SDA, a plurality of auxiliary signal lines SSE and a plurality of black frame insertion signal lines SVB. The auxiliary signal terminals SE of the pixel circuits in a column of sub-pixels may be coupled to at least one auxiliary signal line SSE. The data signal terminals DA of the pixel circuits in a column of sub-pixels may be coupled to at least one data line SDA. The black frame insertion signal terminal VB of the pixel circuit in at least one sub-pixel is coupled to one black frame insertion signal line SVB. The first scan signal terminals GA1 of the pixel circuits in a row of sub-pixels are coupled to at least one first scan signal line SGA1. The second scan signal terminals GA2 of the pixel circuits in a row of sub-pixels are coupled to at least one second scan signal line SGA2. The third scan signal terminals GA3 of the pixel circuits in a row of sub-pixels are coupled to at least one third scan signal line SGA3.

In some embodiments of the present disclosure, as shown in FIG. 5, the auxiliary signal terminals SE of the pixel circuits in a column of sub-pixels may be coupled to one auxiliary signal line SSE, in this way, the detection current may be transmitted through the auxiliary signal line SSE within the blanking time. The second reset voltage is transmitted to the auxiliary signal terminal SE through the auxiliary signal line SSE within time except the blanking time, so as to reduce influence caused by coupling capacitance of the auxiliary signal line SSE.

In some embodiments of the present disclosure, as shown in FIG. 5, the data signal terminals DA of the pixel circuits in a column of sub-pixels may be coupled to one data line SDA, in this way, the data voltage and the first reset voltage may be transmitted through the data line SDA. The first reset voltage is transmitted to the data signal terminal DA through the data line SDA within time except time of transmitting the data voltage, so as to reduce influence caused by coupling capacitance of the data line SDA.

In some embodiments of the present disclosure, as shown in FIG. 5, the black frame insertion signal terminals VB of the pixel circuits in a row of sub-pixels may be coupled to one black frame insertion signal line SVB. In this way, the black frame insertion signal line SVB may be enabled to transmit the black frame insertion voltage to the black frame insertion signal terminal VB. Besides, the black frame insertion voltage may be a fixed voltage, and influence caused by coupling capacitance of the black frame insertion signal line SVB may be reduced.

In some embodiments of the present disclosure, as shown in FIG. 5, the first scan signal terminals GA1 of the pixel circuits in a row of sub-pixels may be coupled to one first scan signal line SGA1, the second scan signal terminals GA2 of the pixel circuits in a row of sub-pixels may be coupled to one second scan signal line SGA2, and the third scan signal terminals GA3 of the pixel circuits in a row of sub-pixels may be coupled to one third scan signal line SGA3.

In some embodiments of the present disclosure, taking two rows and two columns of sub-pixels as an example, as shown in FIG. 5, the gates of the first transistors M1 in a row of sub-pixels spx may be coupled to one first scan signal line SGA1, the gates of the second transistors M2 in a row of sub-pixels spx may be coupled to one second scan signal line SGA2, the gates of the third transistors M3 in a row of sub-pixels spx may be coupled to one third scan signal line SGA3, and the first electrodes of the first transistors M1 in a row of sub-pixels spx may be coupled to one black frame insertion signal line SVB. The first electrodes of the second transistors M2 in a column of sub-pixels spx may be coupled to one data line SDA, and the second electrodes of the third transistors M3 in a column of sub-pixels spx may be coupled to one auxiliary signal line SSE.

In a method for driving some display panels provided by an embodiment of the present disclosure, a display frame may be included, the display frame includes: a plurality of row-drive time periods, and each row-drive time period includes a data writing stage T1, a light-emitting stage T2 and a black frame insertion stage T3. A row of sub-pixels corresponds to one row-drive time period. Besides, the plurality of row-drive time periods are divided into M time period groups, and each time period group includes N row-drive time periods, wherein M≥1, N≥1, and M and N are integers. Besides, as for each time period group, the black frame insertion stage T3 in each row-drive time period in the time period group enters after the data writing stage T1 of the last row-drive time period in the time period group. In this way, all the black frame insertion stages T3 in the same time period group may enter after the data writing stage T1, writing of the data voltage is not affected, and nondestructive black frame insertion is implemented.

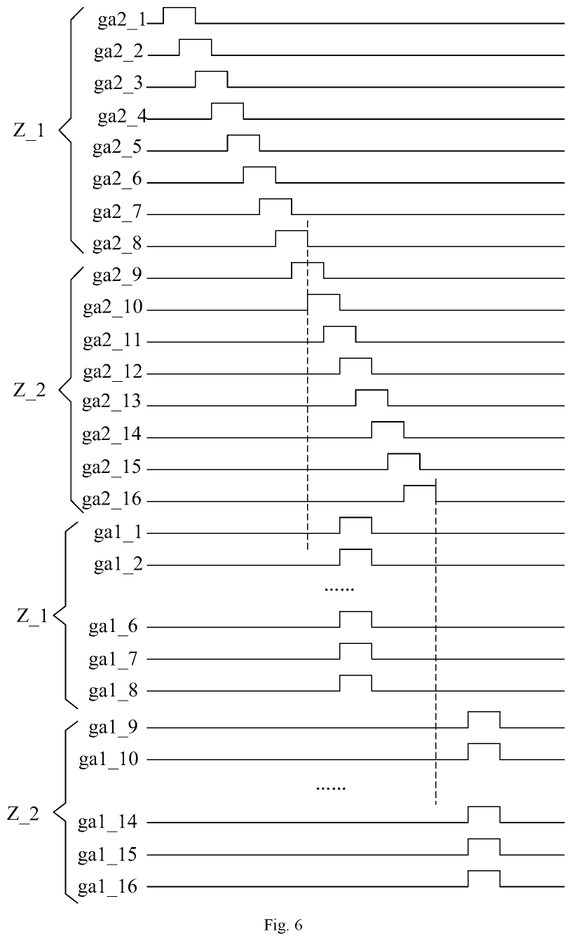

For example, as shown in FIG. 6, taking a first row of sub-pixels to a sixteenth row of sub-pixels as an example, M=2 and N=2 may be set, that is, the row-drive time periods corresponding to the first row of sub-pixels to an eighth row of sub-pixels are put in one time period group Z_1, and the row-drive time periods corresponding to a ninth row of sub-pixels to a sixteenth row of sub-pixels are put in another time period group Z_2. ga1_1-ga1_16 represents signals loaded by the first scan signal terminals GA1 of the first row of sub-pixels to the sixteenth row of sub-pixels, and ga2_1-ga2_16 represents signals loaded by the second scan signal terminals GA2 of the first row of sub-pixels to the sixteenth row of sub-pixels. In the time period group Z_1, after the high level of the signal ga2_8 loaded by the second scan signal terminal GA2 of the eighth row of sub-pixels, the signals loaded by the first scan signal terminals GA1 of the first row of sub-pixels to the eighth row of sub-pixels are high levels, so as to control the first row of sub-pixels to the eighth row of sub-pixels to switch from light emitting to a black picture. In the time period group Z_2, after the high level of the signal ga2_16 loaded by the second scan signal terminal GA2 of the sixteenth row of sub-pixels, the signals loaded by the first scan signal terminals GA1 of the ninth row of sub-pixels to the sixteenth row of sub-pixels are high levels, so as to control the ninth row of sub-pixels to the sixteenth row of sub-pixels to switch from light emitting to a black picture. The others are similar to this and will not be repeated here.

It needs to be noted that values of M and N may be determined according to demands of actual application and are not limited here.

In some embodiments of the present disclosure, as for each time period group, the black frame insertion stage T3 in each row-drive time period in the time period group enters after the light-emitting stage T2 of the last row-drive time period in the time period group. In this way, all the black frame insertion stages T3 in the same time period group may enter after the light-emitting stage T2, further, writing of the data voltage is not affected, and nondestructive black frame insertion is further implemented. For example, as shown in FIG. 6, in the time period group Z_1, after the high level of the signal ga2_8 loaded by the second scan signal terminal GA2 of the eighth row of sub-pixels, after set time (the set time may be determined according to demands of actual application and is not limited here) passes, the signals loaded by the first scan signal terminals GA1 of the first row of sub-pixels to the eighth row of sub-pixels are high levels, so as to control the first row of sub-pixels to the eighth row of sub-pixels to switch from light emitting to a black picture. In the time period group Z_2, after the high level of the signal ga2_16 loaded by the second scan signal terminal GA2 of the sixteenth row of sub-pixels, after set time passes, the signals loaded by the first scan signal terminals GA1 of the ninth row of sub-pixels to the sixteenth row of sub-pixels are high levels, so as to control the ninth row of sub-pixels to the sixteenth row of sub-pixels to switch from light emitting to a black picture. The others are similar to this and will not be repeated here.

In some embodiments of the present disclosure, as for each time period group, the black frame insertion stages T3 in all the row-drive time periods in the time period group may enter at the same time. Thus, black frame insertion may be performed on the sub-pixels corresponding to the same time period group at the same time. For example, as shown in FIG. 6, in the time period group Z_1, the signals loaded by the first scan signal terminals GA1 of the first row of sub-pixels to the eighth row of sub-pixels are the high levels at the same time, so as to control the first row of sub-pixels to the eighth row of sub-pixels to switch from light emitting to a black picture at the same time. In the time period group Z_2, the signals loaded by the first scan signal terminals GA1 of the ninth row of sub-pixels to the sixteenth row of sub-pixels are the high levels at the same time, so as to control the ninth row of sub-pixels to the sixteenth row of sub-pixels to switch from light emitting to a black picture at the same time. The others are similar to this and will not be repeated here.

A work process of the display panel provided by the embodiment of the present disclosure is described below with reference to FIG. 5 and FIG. 6.

ga1_1-ga1_16 represents the signals loaded by the first scan signal terminals GA1 in the row-drive time periods corresponding to the first row of sub-pixels to the sixteenth row of sub-pixels, and ga2_1-ga2_16 represents the signals loaded by the second scan signal terminals GA2 in the row-drive time periods corresponding to the first row of sub-pixels to the sixteenth row of sub-pixels. Besides, the signals loaded by the third scan signal terminals GA3 in the row-drive time periods corresponding to the first row of sub-pixels to the sixteenth row of sub-pixels are the same as the signals loaded by the second scan signal terminals GA2 in the row-drive time periods corresponding to the first row of sub-pixels to the sixteenth row of sub-pixels, thereby not being illustrated in FIG. 6.

When the signal ga2_1 is a high level, the data voltage may be input into the first row of sub-pixels, then the high level is switched to a low level, and the first row of sub-pixels may implement light emitting. When the signal ga2_2 is a high level, the data voltage may be input into the second row of sub-pixels, then the high level is switched to a low level, and the second row of sub-pixels may implement light emitting. When the signal ga2_3 is the high level, the data voltage may be input into the third row of sub-pixels, then the high level is switched to a low level, and the third row of sub-pixels may implement light emitting . . . . When the signal ga2_8 is the high level, the data voltage may be input into the eighth row of sub-pixels, then the high level is switched to a low level, and the eighth row of sub-pixels may implement light emitting. When the signal ga2_9 is the high level, the data voltage may be input into the ninth row of sub-pixels, then the high level is switched to a low level, and the ninth row of sub-pixels may implement light emitting . . . . When the signal ga2_16 is the high level, the data voltage may be input into the sixteenth row of sub-pixels, then the high level is switched to a low level, and the sixteenth row of sub-pixels may implement light emitting. In this way, the data voltage may be input row by row.

After the high level of the signal ga2_8 loaded by the second scan signal terminal GA2 of the eighth row of sub-pixels, after set time passes, the signals ga1_1-ga1_8 loaded by the first scan signal terminals GA1 of the first row of sub-pixels to the eighth row of sub-pixels are high levels at the same time, the second reset voltage transmitted on the black frame insertion signal line SVB is input into the gates of the drive transistors M0 of the first row of sub-pixels to the eighth row of sub-pixels, so as to control the first row of sub-pixels to the eighth row of sub-pixels to switch from light emitting to a black picture at the same time. The high levels in the signals ga1_1-ga1_8 are after the high levels in the signals ga2-1-ga2_8, so a process of inserting a black picture into the first row of sub-pixels to the eighth row of sub-pixels will not occupy time of data voltage writing, and thus a duration of data voltage writing may not be occupied.

After the high levels in the signal ga2_16 loaded by the second scan signal terminal GA2 of the sixteenth row of sub-pixels, after set time passes, the signals ga1_9-ga1_16 loaded by the first scan signal terminals GA1 of the ninth row of sub-pixels to the sixteenth row of sub-pixels are the high levels at the same time, and the second reset voltage transmitted on the black frame insertion signal line SVB is input into the gates of the drive transistors M0 of the first row of sub-pixels to the eighth row of sub-pixels, so as to control the ninth row of sub-pixels to the sixteenth row of sub-pixels to switch from light emitting to a black picture at the same time. The high levels in the signals ga1_9-ga1_16 are after the high levels in the signals ga2_9-ga2_16, so a process of inserting a black picture into the ninth row of sub-pixels to the sixteenth row of sub-pixels will not occupy time of data voltage writing, and thus a duration of data voltage writing may not be occupied.

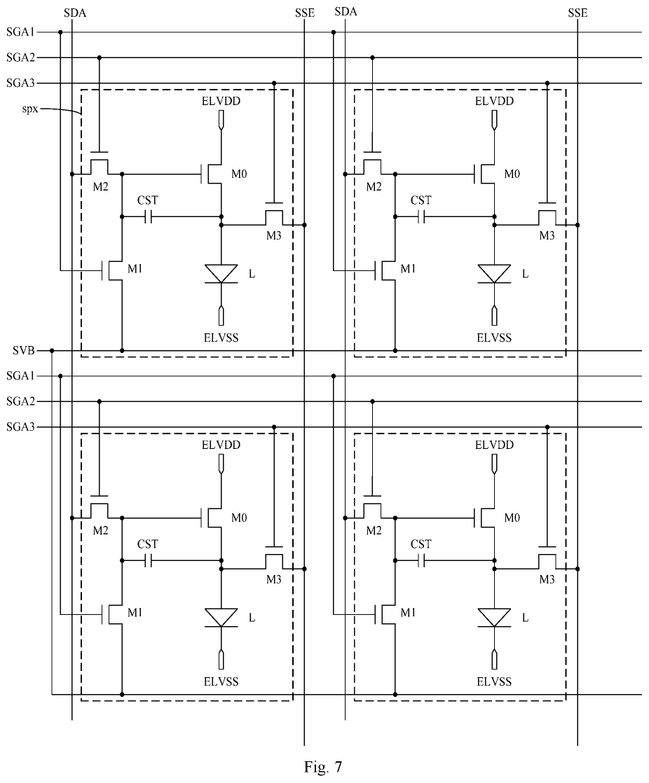

An embodiment of the present disclosure provides a schematic diagram of some structures of the display panel, as shown in FIG. 7, which makes variation for implementation of the above embodiment. Only difference between the embodiment and the above embodiment is described below, and the same parts between them are not repeated here.

In some embodiments of the present disclosure, the black frame insertion signal lines SVB corresponding to at least two adjacent rows of sub-pixels may be mutually coupled. For example, as shown in FIG. 7, the black frame insertion signal lines SVB corresponding to the two adjacent rows of sub-pixels may be mutually coupled. In other words, the black frame insertion signal lines SVB corresponding to the first row of sub-pixels and the second row of sub-pixels are mutually coupled, the black frame insertion signal lines SVB corresponding to the third row of sub-pixels and the fourth row of sub-pixels are mutually coupled, and the black frame insertion signal lines SVB corresponding to the fifth row of sub-pixels and the sixth row of sub-pixels are mutually coupled. Alternatively, the black frame insertion signal lines SVB corresponding to three adjacent rows of sub-pixels may be mutually coupled. In other words, the black frame insertion signal lines SVB corresponding to the first row of sub-pixels to the third row of sub-pixels are mutually coupled, the black frame insertion signal lines SVB corresponding to the fourth row of sub-pixels and the sixth row of sub-pixels are mutually coupled, and the black frame insertion signal lines SVB corresponding to the seventh row of sub-pixels to the ninth row of sub-pixels are mutually coupled. Alternatively, the black frame insertion signal lines SVB corresponding to four adjacent rows of sub-pixels may be mutually coupled. In other words, the black frame insertion signal lines SVB corresponding to the first row of sub-pixels to the fourth row of sub-pixels are mutually coupled, the black frame insertion signal lines SVB corresponding to the fifth row of sub-pixels to the eighth row of sub-pixels are mutually coupled, and the black frame insertion signal lines SVB corresponding to the ninth row of sub-pixels to the twelfth row of sub-pixels are mutually coupled.

It needs to be noted that a work process of the display panel shown in FIG. 7 may be basically the same as the work process of the display panel shown in FIG. 5, which is not repeated here.

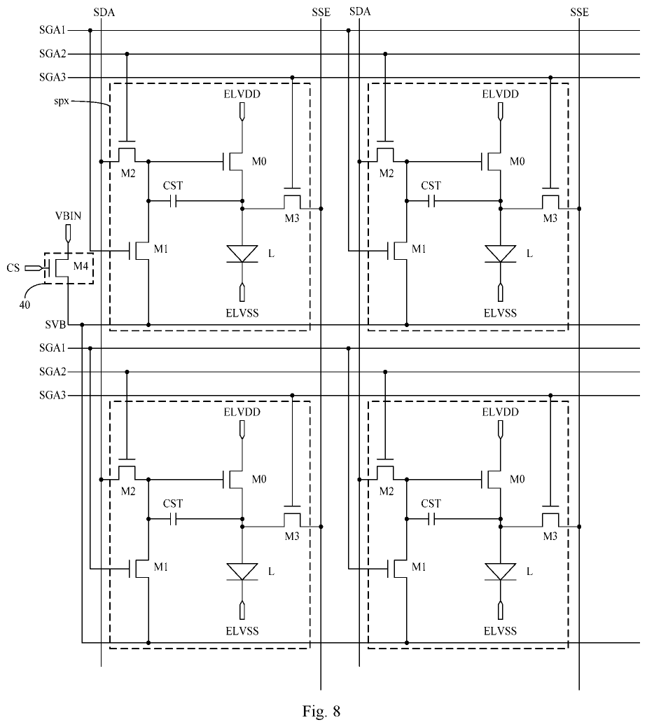

An embodiment of the present disclosure provides yet another schematic diagram of some structures of the display panel, as shown in FIG. 8, which makes variation for an implementation of the above embodiment. Only difference between the embodiment and the above embodiment is described below, and the same parts between them are not repeated here.

In some embodiments of the present disclosure, when the black frame insertion signal lines SVB corresponding to at least two adjacent rows of sub-pixels are mutually coupled, the display panel may also include a black frame insertion switching circuit 40, and the mutually coupled black frame insertion signal lines SVB are coupled to a black frame insertion voltage input terminal VBIN through at least one black frame insertion switching circuit 40. The black frame insertion switching circuit 40 is configured to input a signal, loaded by the black frame insertion voltage input terminal VBIN, into the coupled black frame insertion signal lines SVB in response to a signal of the black frame insertion control signal terminal CS. For example, the mutually coupled black frame insertion signal lines SVB are coupled to the black frame insertion voltage input terminal VBIN through a black frame insertion switching circuit 40. The mutually coupled black frame insertion signal lines SVB may be also coupled to the black frame insertion voltage input terminal VBIN through two black frame insertion switching circuits 40. The mutually coupled black frame insertion signal lines SVB may be also coupled to the black frame insertion voltage input terminal VBIN through three black frame insertion switching circuits 40. For example, as shown in FIG. 8, when the black frame insertion signal lines SVB corresponding to the two adjacent rows of sub-pixels are mutually coupled, the two black frame insertion signal lines SVB may be coupled to the black frame insertion voltage input terminal VBIN through a black frame insertion switching circuit 40.

In some embodiments of the present disclosure, as shown in FIG. 8, the black frame insertion switching circuit 40 may include a fourth transistor M4. A gate of the fourth transistor M4 is coupled to a black frame insertion control signal terminal CS, a first electrode of the fourth transistor M4 is coupled to the black frame insertion voltage input terminal VBIN, and a second electrode of the fourth transistor M4 is coupled to the black frame insertion signal line SVB. For example, the fourth transistor M4 may be turned on under control of an effective level of a signal loaded by the black frame insertion control signal terminal CS and may be turned off under control of an ineffective level of the signal loaded by the black frame insertion control signal terminal CS. For example, as shown in FIG. 8, the fourth transistor M4 is an N-type transistor, so the effective level of the signal loaded by the black frame insertion control signal terminal CS is a high level, and the ineffective level of the signal loaded by the black frame insertion control signal terminal CS is a low level. If the fourth transistor M4 is a P-type transistor, the effective level of the signal loaded by the black frame insertion control signal terminal CS is a low level, and the ineffective level of the signal loaded by the black frame insertion control signal terminal CS is a high level.

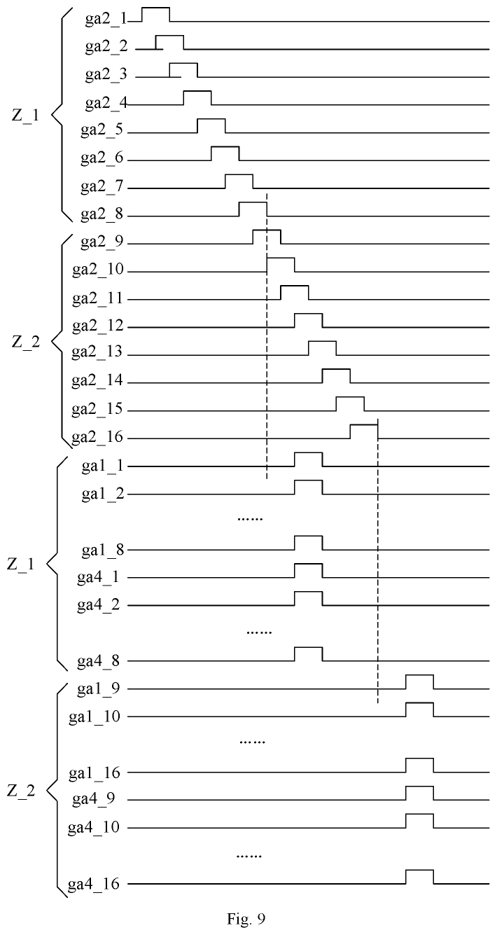

For example, signals loaded by the first scan signal terminal GA1 and the black frame insertion control signal terminal CS corresponding to the same row of sub-pixels may be the same, so that difficulty of signal designing may be lowered. For example, as shown in FIG. 9, ga1_1-ga1_16 represent the signals loaded by the first scan signal terminals GA1 of the first row of sub-pixels to the sixteenth row of sub-pixels, and ga2_1-ga2_16 represent the signals loaded by the second scan signal terminals GA2 of the first row of sub-pixels to the sixteenth row of sub-pixels. ga4_1-ga4_16 represent signals loaded by the black frame insertion control signal terminals CS of the first row of sub-pixels to the sixteenth row of sub-pixels. In the time period group Z_1, the signal loaded by the first scan signal terminal GA1 and the signal loaded by the black frame insertion control signal terminal CS are high levels at the same time, so that the first transistor M1 and the fourth transistor M4 may be controlled to be turned on at the same time, and thus a black frame insertion voltage is input into the gate of the drive transistor M0. In the time period group Z_2, the signal loaded by the first scan signal terminal GA1 and the signal loaded by the black frame insertion control signal terminal CS are high levels at the same time, so that the first transistor M1 and the fourth transistor M4 may be controlled to be turned on at the same time, and thus the black frame insertion voltage is input into the gate of the drive transistor M0.

It needs to be noted that a work process of the display panel shown in FIG. 8 may be basically the same as the work process of the display panel shown in FIG. 5 and is not repeated here.

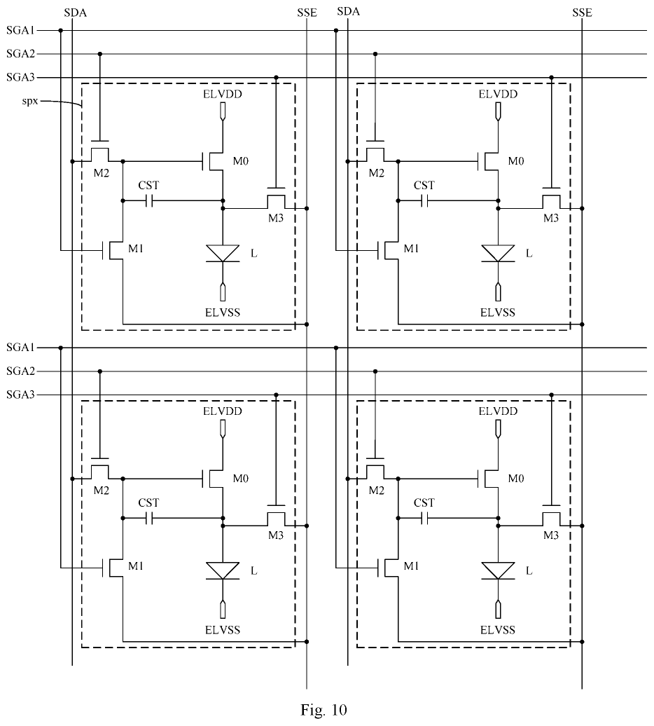

An embodiment of the present disclosure provides yet another schematic diagram of some structures of the display panel, as shown in FIG. 10, which makes variation for an implementation of the above embodiment. Only difference between the embodiment and the above embodiment is described below, and the same parts between them are not repeated here.

In some embodiments of the present disclosure, the auxiliary signal terminal SE and the black frame insertion signal terminal VB may be one same signal terminal. In this way, the first reset voltage and the second reset voltage may be the same voltage. For example, as shown in FIG. 10, the first electrode of the first transistor M1 and the second electrode of the third transistor M3 are coupled to the auxiliary signal line SSE. In this way, the quantity of signal lines may be reduced, an occupied space of the signal lines is reduced, so that spare space may be used for arranging sub-pixels, and the quantity of sub-pixels is increased.

A work process of the display panel provided by the embodiment of the present disclosure is described below with reference to FIG. 10 and FIG. 6.

When the signal ga2_1 is the high level, the data voltage may be input into the first row of sub-pixels, then the high level is switched to a low level, and the first row of sub-pixels may implement light emitting. When the signal ga2_2 is the high level, the data voltage may be input into the second row of sub-pixels, then the high level is switched to a low level, and the second row of sub-pixels may implement light emitting. When the signal ga2_3 is the high level, the data voltage may be input into the third row of sub-pixels, then the high level is switched to a low level, and the third row of sub-pixels may implement light emitting . . . . When the signal ga2_8 is the high level, the data voltage may be input into the eighth row of sub-pixels, then the high level is switched to a low level, and the eighth row of sub-pixels may implement light emitting. When the signal ga2_9 is the high level, the data voltage may be input into the ninth row of sub-pixels, then the high level is switched to a low level, and the ninth row of sub-pixels may implement light emitting . . . . When the signal ga2_16 is the high level, the data voltage may be input into the sixteenth row of sub-pixels, then the high level is switched to a low level, and the sixteenth row of sub-pixels may implement light emitting. In this way, the data voltage may be input row by row.

Besides, when the signal ga3_1 is the high level, the first reset voltage may be input into the first row of sub-pixels, then the high level is switched to a low level, and the first row of sub-pixels may implement light emitting. When the signal ga3_2 is the high level, the first reset voltage may be input into the second row of sub-pixels, then the high level is switched to a low level, and the second row of sub-pixels may implement light emitting. When the signal ga3_3 is the high level, the first reset voltage may be input into the third row of sub-pixels, then the high level is switched to a low level, and the third row of sub-pixels may implement light emitting . . . . When the signal ga3_8 is the high level, the first reset voltage may be input into the eighth row of sub-pixels, then the high level is switched to a low level, and the eighth row of sub-pixels may implement light emitting. When the signal ga3_9 is the high level, the first reset voltage may be input into the ninth row of sub-pixels, then the high level is switched to a low level, and the ninth row of sub-pixels may implement light emitting . . . . When the signal ga3_16 is the high level, the first reset voltage may be input into the sixteenth row of sub-pixels, then the high level is switched to a low level, and the sixteenth row of sub-pixels may implement light emitting. In this way, the data voltage may be input row by row. It needs to be noted that the signals loaded by the second scan signal terminal GA2 and the third scan signal terminal GA3 corresponding to the same row of sub-pixels may be the same.

After the high level of the signal ga2_8 loaded by the second scan signal terminal GA2 of the eighth row of sub-pixels, after set time passes, the signals ga1_1-ga1_8 loaded by the first scan signal terminals GA1 of the first row of sub-pixels to the eighth row of sub-pixels are high levels at the same time, and the first reset voltage transmitted on the auxiliary signal line SSE is input into the gates of the drive transistors M0 of the first row of sub-pixels to the eighth row of sub-pixels, so as to control the first row of sub-pixels to the eighth row of sub-pixels to switch from light emitting to a black picture at the same time. The high levels in the signals ga1_1-ga1_8 are after the high levels in the signals ga2_1-ga2_8, so a process of inserting a black picture into the first row of sub-pixels to the eighth row of sub-pixels will not occupy time of data voltage writing, and thus a duration of data voltage writing may not be occupied.

After the high level of the signal ga2_16 loaded by the second scan signal terminal GA2 of the sixteenth row of sub-pixels, after set time passes, the signals ga1_9-ga1_16 loaded by the first scan signal terminals GA1 of the ninth row of sub-pixels to the sixteenth row of sub-pixels are the high levels at the same time, the first reset voltage transmitted on the auxiliary signal line SSE is input into the gates of the drive transistors M0 of the first row of sub-pixels to the eighth row of sub-pixels, so as to control the ninth row of sub-pixels to the sixteenth row of sub-pixels to switch from light emitting to a black picture at the same time. The high levels in the signals ga1_9-ga1_16 are after the high levels in the signals ga2_9-ga2_16, so a process of inserting a black picture into the ninth row of sub-pixels to the sixteenth row of sub-pixels will not occupy time of data voltage writing, and thus a duration of data voltage writing may not be occupied.

During specific implementation, in the embodiment of the present disclosure, the display apparatus may be: a mobile phone, a tablet computer, a television, a display, a notebook computer, a digital photo frame, a navigator and any product or component with a display function. Other necessary components of the display apparatus should be understood by those ordinarily skilled in the art and will not be repeated here, nor should serve as a limitation on the present disclosure.

Those skilled in the art should understand that the embodiments of the present disclosure may be provided as a method, a system or a computer program product. Thus, the present disclosure may adopt forms of a hardware-only embodiment, a software-only embodiment or an embodiment combining hardware and software. Besides, the present disclosure may adopt a form of a computer program product implemented on one or more computer-sensitive storage media (including but not limited to a disc memory, CD-ROM, an optical memory and the like) containing computer-sensitive program codes.

The present disclosure is described with reference to flow charts and/or block diagrams of a method, a device (system) and a computer program product according to the embodiments of the present disclosure. It should be understood that each flow and/or block in the flow charts and/or block diagrams and combinations of flows and/or block diagrams in the flow charts and/or block diagrams may be implemented by computer program instructions. These computer program instructions may be provided for a processor of a general-purpose computer, a special-purpose computer, an embedded processor or other programmable data processing devices so as to generate a machine so that instructions executed by the processor of the computer or other programmable data processing devices generate an apparatus which is used for implementing functions specified in one or more flows in the flow charts and/or one or more blocks in the block diagrams.

These computer program instructions may be also stored in a computer readable memory which can guide the computer or other programmable data processing devices to work in a specific mode so that instructions stored in the computer readable memory generate a manufacture including an instruction apparatus, and the instruction apparatus implements functions specified in one or more flows in the flow charts and/or one or more blocks in the block diagrams.

These computer program instructions may be also loaded onto the computer or other programmable data processing devices, so that a series of operation steps are executed on the computer or other programmable devices to generate processing implemented by the computer, and thus the instructions executed on the computer or other programmable devices provide steps used for implementing functions specified in one or more flows in the flow charts and/or one or more blocks in the block diagrams.

Although preferred embodiments of the present disclosure are already described, those skilled in the art can make other changes and modifications to these embodiments once they know the basic inventive concept. Therefore, the appended claims are intended to be constructed as including the preferred embodiments and all changes and modifications falling within the scope of the present disclosure.

Apparently, those skilled in the art can make various changes and variations to the embodiments of the present disclosure without departing from the spirit and the scope of the embodiments of the present disclosure. In this case, if these changes and variations of the embodiments of the present disclosure fall within the scope of the claims of the present disclosure and their equivalents, the present disclosure is also intended to contain these changes and variations.

1. A display panel, comprising:
a plurality of sub-pixels, wherein each of the sub-pixels comprises a pixel circuit, and the pixel circuit comprises:
a light-emitting device;
a drive transistor, configured to, at a light-emitting stage, generate a drive current driving the light-emitting device to emit light according to a data voltage;
a voltage control circuit, coupled to the drive transistor; wherein the voltage control circuit is configured to, at a data writing stage, input the data voltage into the drive transistor; and
a black frame insertion control circuit, coupled to the drive transistor, wherein the black frame insertion control circuit is configured to, at a black frame insertion stage after the light-emitting stage, control the drive transistor to stop generating the drive current.

2. The display panel according to claim 1, wherein the black frame insertion control circuit is coupled to a gate of the drive transistor; and, the black frame insertion control circuit is further configured to, in response to a signal loaded by a first scan signal terminal, provide a signal loaded by a black frame insertion signal terminal for the gate of the drive transistor so as to control the drive transistor to stop generating the drive current.

3. The display panel according to claim 2, wherein the black frame insertion control circuit comprises: a first transistor; and
a gate of the first transistor is coupled to the first scan signal terminal, a first electrode of the first transistor is coupled to the black frame insertion signal terminal, and a second electrode of the first transistor is coupled to the gate of the drive transistor.

4. The display panel according to claim 1, wherein the voltage control circuit is coupled to the gate of the drive transistor and the second electrode of the drive transistor; and
the voltage control circuit is configured to, in response to a signal loaded by a second scan signal terminal, input the data voltage loaded by a data signal terminal into the gate of the drive transistor.

5. The display panel according to claim 4, wherein the voltage control circuit comprises a second transistor and a storage capacitor;
a gate of the second transistor is coupled to the second scan signal terminal, a first electrode of the second transistor is coupled to the data signal terminal, and a second electrode of the second transistor is coupled to the gate of the drive transistor; and
a first electrode plate of the storage capacitor is coupled to the gate of the drive transistor, and a second electrode plate of the storage capacitor is coupled to the second electrode of the drive transistor.

6. The display panel according to claim 1, wherein the pixel circuit further comprises an auxiliary circuit; and
the auxiliary circuit is coupled to a second electrode of the drive transistor, and the auxiliary circuit is configured to, in response to a signal of a third scan signal terminal, conduct an auxiliary signal terminal with the second electrode of the drive transistor.

7. The display panel according to claim 6, wherein the auxiliary circuit comprises: a third transistor; and
a gate of the third transistor is coupled to the third scan signal terminal, a first electrode of the third transistor is coupled to the second electrode of the drive transistor, and a second electrode of the third transistor is coupled to the auxiliary signal terminal.

8. The display panel according to claim 7, further comprising: a plurality of auxiliary signal lines;
wherein auxiliary signal terminals of pixel circuits in a column of sub-pixels are coupled to at least one of the auxiliary signal lines.

9. The display panel according to claim 8, wherein the auxiliary signal terminal and a black frame insertion signal terminal are the same signal terminal.

10. The display panel according to claim 1, further comprising: a plurality of black frame insertion signal lines; and
a black frame insertion signal terminal of the pixel circuit in at least one sub-pixel is coupled to one black frame insertion signal line.

11. The display panel according to claim 10, wherein black frame insertion signal terminals of pixel circuits in a row of sub-pixels are coupled to one black frame insertion signal line.

12. The display panel according to claim 10, wherein black frame insertion signal lines corresponding to at least two adjacent rows of sub-pixels are mutually coupled.

13. The display panel according to claim 12, further comprising: at least one black frame insertion switching circuit; the mutually coupled black frame insertion signal lines are coupled to a black frame insertion voltage input terminal through the at least one black frame insertion switching circuit; and
the black frame insertion switching circuit is configured to, in response to a signal of a black frame insertion control signal terminal, input a signal loaded by the black frame insertion voltage input terminal into the mutually coupled black frame insertion signal lines.

14. The display panel according to claim 13, wherein the black frame insertion switching circuit comprises a fourth transistor; and
a gate of the fourth transistor is coupled to the black frame insertion control signal terminal, a first electrode of the fourth transistor is coupled to the black frame insertion voltage input terminal, and a second electrode of the fourth transistor is coupled to the black frame insertion signal line.

15. A display apparatus, comprising the display panel according to claim 1.

16. A driving method of the display panel according to claim 1, wherein one display frame comprises: a plurality of row-drive time periods; each of the row-drive time periods comprises a data writing stage, a light-emitting stage and a black frame insertion stage; wherein the plurality of row-drive time periods are divided into M time period groups, and each of the time period groups comprises N row-drive time periods, M≥1, N≥1, and M and N are integers; and
for each of the time period groups, the black frame insertion stage in each of the row-drive time periods in the time period group enters after a data writing stage of a last row-drive time period in the time period group.

17. The driving method according to claim 16, wherein for each of the time period groups, the black frame insertion stage in each of the row-drive time periods in the time period group enters after a light-emitting stage of a last row-drive time period in the time period group.

18. The driving method according to claim 17, wherein for each of the time period groups, black frame insertion stages in all the row-drive time periods in the time period group enter at the same time.

19. The display panel according to claim 2, wherein the voltage control circuit is coupled to the gate of the drive transistor and the second electrode of the drive transistor; and
the voltage control circuit is configured to, in response to a signal loaded by a second scan signal terminal, input the data voltage loaded by a data signal terminal into the gate of the drive transistor.

20. The display panel according to claim 3, wherein the voltage control circuit is coupled to the gate of the drive transistor and the second electrode of the drive transistor; and
the voltage control circuit is configured to, in response to a signal loaded by a second scan signal terminal, input the data voltage loaded by a data signal terminal into the gate of the drive transistor.
